(19) United States
(12) Patent Application Publication
(10) Pub. No.: US 2010/0231957 A1
(43) Pub. Date: Sep. 16, 2010

(54) METHOD OF CONTROLLING PRINTING AND PRINTING CONTROL APPARATUS THEREOF

(75) Inventors: Hung-soo PARK, Seoul (KR); Jay-kyoo Kang, Yongsin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/624,574

(22) Filed: Nov. 24, 2009

(30) Foreign Application Priority Data
Mar. 10, 2009 (KR) 2009-20271

(51) Int. Cl. G06F 3/12

(52) U.S. Cl. 358/1.15

(57) ABSTRACT

A printing control method includes displaying at least one image forming apparatus connectable to a printing control apparatus, receiving selection of an image forming apparatus from among the displayed image forming apparatuses, setting the at least one selected image forming apparatus as a printable image forming apparatus, generating printing data using a printing language corresponding to the set image forming apparatus, and transmitting generate printing data to the at least one selected image forming apparatus. Accordingly, a user may perform a printing job for a plurality of image forming apparatuses operated in different languages using a universal printer driver.

### CROSS-REFERENCE TO RELATED APPLICATIONS

This application claims priority under 35 USC §119 from Korean Patent Application No. 10-2009-20271, filed in the Korean Intellectual Property Office on Mar. 10, 2009, the disclosure of which is incorporated herein by reference.

### BACKGROUND

1. Field of the General Inventive Concept

Apparatuses and methods consistent with the present general inventive concept relate to a method of controlling printing and a printing control apparatus thereof, and more particularly, to a method of controlling printing using a single universal printer driver for a plurality of image forming apparatuses which are operated in different printing languages and a printing control apparatus thereof.

2. Description of the Related Art

In general, in order to print a document written in an application program of a computer using an image forming apparatus such as a printer or a multi-function printer (MFP), the printing control apparatus such as a computer should be equipped with a printer driver provided by a manufacturer of the image forming apparatus to control printing function of the image forming apparatus.

Recently, a user is able to use a plurality of image forming apparatuses by connecting them to a terminal device via a local or a local area network (LAN), and control printing function of the plurality of image forming apparatuses using a single universal printer driver.

FIG. 1 is a schematic view illustrating a printing method of a conventional image forming apparatus. Referring to FIG. 1, a plurality of image forming apparatuses 20a to 20d are connected to the user terminal device 10. Specifically, the image forming apparatus 20a is connected to the user terminal device 10 via a local system, and the image forming apparatuses 20b to 20d are connected to the user terminal 20 via a network. In this case, a user is able to control printing function of the plurality of image forming apparatuses 20a to 20d using a single universal printer driver.

However, a conventional universal printer driver could not control printing function of all image forming apparatuses. Specifically, since the conventional universal printer driver supported only one printing language for a driver, it was not able to control printing function of other image forming apparatuses which were operated in other printing languages.

For instance, if the image forming apparatuses 20a and 20b are operated in a PS printing language, the image forming apparatus 20c is operated in a SPL printing language, and the image forming apparatus 20d is operated in a PCL printing language, a universal printer driver supporting only the PS printing language is able to perform printing jobs of the image forming apparatus 20a and 20b. If a user desires to perform printing jobs of the image forming apparatus 20c and the image forming apparatus 20d, the user has to additionally install a SPL driver or and PCL driver for each image forming apparatus, or a universal printer driver supporting the SPL printing language and the PCL printing language, and this causes inconvenience to the user.

### SUMMARY

Exemplary embodiments of the present general inventive concept address at least the above problems and/or disadvantages and other disadvantages not described above. Also, the present general inventive concept is not required to overcome the disadvantages described above, and an exemplary embodiment of the present general inventive concept may not overcome any of the problems described above.

Additional features and utilities of the present general inventive concept will be set forth in part in the description which follows and, in part, will be obvious from the description, or may be learned by practice of the general inventive concept.

The present general inventive concept provides a method of controlling printing using a single universal printer driver for a plurality of image forming apparatuses which are operated in different printing languages and a printing control apparatus thereof.

Embodiments of the present general inventive concept may be achieved by displaying at least one image forming apparatus connectable to the printing control apparatus, receiving selection of at least one image forming apparatus from among the displayed image forming apparatuses, setting at least one image forming apparatus from among the selected image forming apparatuses as a printable image forming apparatus, generating printing data using a printing language corresponding to the set image forming apparatus, and transmitting the generated printing data to the at least one selected image forming apparatus.

The generating printing data may generate printing data using a printer driver corresponding to a printing language of the selected image forming apparatus in the universal printer driver.

The setting at least one image forming apparatus as a printable image forming apparatus may include searching at least one printing language supported by the selected image forming apparatus and setting a printing language from among the searched printing languages as a printing language and registering the selected image forming apparatus as a printable image forming apparatus.

The printing control method may further include displaying at least one printing language supported by the selected image forming apparatus.

The registering a printable image forming apparatus may set the selected image forming apparatus as a default image forming apparatus.

The printing control method may further include displaying change of a default image forming apparatus.

The displaying may displays the connected image forming apparatus distinctively according to a printing language supported by the image forming apparatus, or display a printing language supported by the image forming apparatus together with the image forming apparatus.

The displaying may arrange and display the connected image forming apparatus according to at least one of printing history and connection priority of the connected image forming apparatus.

The displaying may be performed when a user's command to change an image forming apparatus is received, when a new image forming apparatus is connected to the printing control apparatus, or when a printing job cannot be performed in a predetermined default image forming apparatus.

Embodiments of the present general inventive concept may also be achieved by displaying at least one image forming apparatus connectable to the printing control apparatus and a printing language supported by the image forming apparatus, receiving selection of one of the displayed image forming apparatus and the printing language, generating printing data using the selected printing language, and transmitting the generated printing data to the image forming apparatus.

Embodiments of the present general inventive concept may also be achieved by providing a universal printer driver capable of performing a printing job for a plurality of image forming apparatuses and supporting a plurality of printing languages, a user interface unit to display at least one image forming apparatus connectable to the printing control apparatus and receive selection an image forming apparatus from among the displayed image forming apparatuses, and a control unit to generate printing data in a printing language corresponding to the at least one selected image forming apparatus using the universal printer driver and transmit the generated printing data to the at least one selected image forming apparatus.

The universal printer driver may include a search unit to search at least one image forming apparatus connectable to the printing control apparatus and search a printing language supported by the at least one image forming apparatus, a setting unit to set the at least one image forming apparatus as a printable image forming apparatus based on the searched printing language, and a driver unit to include a plurality of printer drivers corresponding to a plurality of printing languages and generate printing data using a printer driver corresponding to the selected image forming apparatus.

The control unit may transmit the generated printing data via a port corresponding to the at least one selected image forming apparatus.

The setting unit may set the searched image forming apparatus as a default image forming apparatus.

The user interface unit may inform that a default image forming apparatus is changed.

The user interface unit may display the connected image forming apparatuses distinctively according to a printing language supported by the image forming apparatus or display a printing language supported by the image forming apparatus together with the image forming apparatus.

The user interface unit may display at least one image forming apparatus connectable to the printing control apparatus and printing languages supported by the connectable image forming apparatus, and receive section of a printing language from among the displayed languages, and the control unit may generate printing data in the selected printing language using the universal printer driver and transmit the generated printing data to the at least one selected image forming apparatus.

The user interface unit may arrange and display the connected image forming apparatuses according to at least one of printing history or connection priority of the connected image forming apparatus.

The user interface unit may be operated when a user's command to change an image forming apparatus is received, when a new image forming apparatus is connected to the printing control apparatus, or when a printing job cannot be performed in a predetermined default image forming apparatus.

Embodiments of the present general inventive concept may also be achieved by determining desired printing options to correspond to an image forming apparatus, displaying a plurality of image forming apparatuses with different printing options and printing languages supported by the image forming apparatuses, selecting an image forming apparatus to correspond to the desired printing options, and generating printing data in a printing language to correspond to the selected image forming apparatus with the selected printing options.

The method may also include determining whether a displayed image forming apparatus is able to print the desired printing options.

Embodiments of the present general inventive concept may also be achieved by providing a control unit to determine at least one printing option of an image forming apparatus, a user interface unit to display a plurality of image forming apparatuses with different sets of printing options and printing languages supported by the image forming apparatuses, and a universal driver unit to search available image forming apparatuses, set an image forming apparatus as a printable image forming apparatus, and generate printing data in a printing language to correspond to the printing options of the selected image forming apparatus.

The control unit may determine whether a displayed image forming apparatus is able to print the at least one printing option.

### BRIEF DESCRIPTION OF THE DRAWINGS

The above and/or other features and utilities of the present general inventive concept will be more apparent by describing certain exemplary embodiments of the present general inventive concept with reference to the accompanying drawings, in which:

FIG. 1 is a schematic view illustrating a conventional printing method of an image forming apparatus;

FIG. 2 is a block diagram illustrating the structure of a printing control apparatus according to an exemplary embodiment of the present general inventive concept;

FIG. 3 to FIG. 7 are exemplary views illustrating a user interface window which may be displayed in a printing control apparatus according to an exemplary embodiment of the present general inventive concept; and

FIG. 8 and FIG. 9 are flow charts illustrating a printing control method according to an exemplary embodiment of the present general inventive concept.

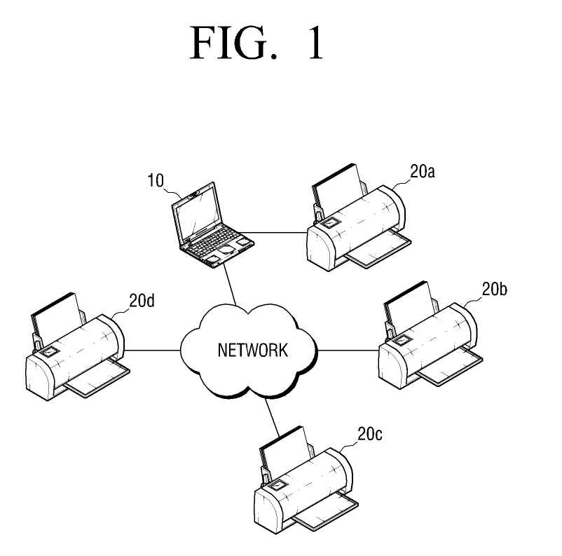

### DETAILED DESCRIPTION OF THE EMBODIMENTS

Exemplary embodiments of the present general inventive concept will now be described in greater detail with reference to the accompanying drawings.

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

In the following description, the same drawing reference numerals are used for the same elements even in different drawings. The matters defined in the description, such as detailed construction and elements, are provided to assist in a comprehensive understanding of the present general inventive concept. Thus, it is apparent that the present general inventive concept can be carried out without those specifically defined matters. Also, well-known functions or constructions are not described in detail since they would obscure the present general inventive concept with unnecessary detail.

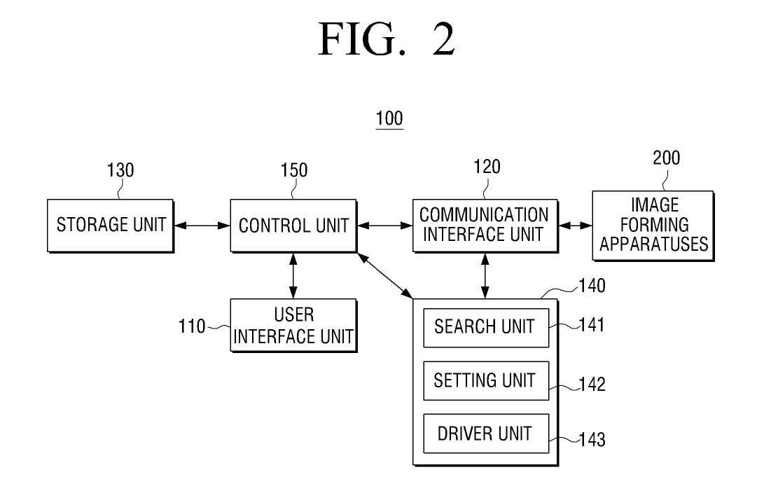

FIG. 2 is a block diagram illustrating a printing control apparatus 100 according to an exemplary embodiment of the present general inventive concept. Referring to FIG. 2, the present printing control apparatus 100 may include a user interface unit 110, a communication interface unit 120, a storage unit 130, a universal printer driver unit 140, and a control unit 150.

The user interface unit 110 may include a plurality of function keys with which a user may set up or select various functions supported by the printing control apparatus 100, and may display diverse information provided by the printing control apparatus. The user interface unit 110 may be configured as a device to realize input and output simultaneously such as a touch pad, or a device combining a mouse and a monitor.

The user interface unit 110 may display a representation of at least one image forming apparatus connectable to the printing control apparatus 100, and may receive a selection of at least one image forming apparatus from among the displayed image forming apparatuses. Specifically, the user interface unit 110 may generate a user interface (UI) which displays one or more representations of a plurality of image forming apparatuses currently connected to the printing control apparatus 100 in a list, pictorial, or other form. In this case, the user interface unit 110 may also display different printing languages supported by the connected image forming apparatuses, and may display each printing language supported by the connected image forming apparatuses distinctively. Accordingly, a user may select at least one of a plurality of image forming apparatuses to perform a printing job or an image forming apparatus to set as a default image forming apparatus via the displayed user interface window. Detailed description regarding the user interface window will be provided later.

The communication interface unit 120 can be wired or wirelessly connected to a plurality of image forming apparatuses 200, and may provide converted printing data with regard to a printing job to an image forming apparatus. Specifically, the communication interface unit 120 may be configured to connect the printing control apparatus 100 to an external apparatus, and may be formed as a parallel port, a universal serial bus (USB) port, a wireless module, etc.

In addition, the communication interface unit 120 may receive and analyze information regarding an image forming apparatus from each connected image forming apparatus. Specifically, the communication interface unit 120 may analyze information regarding an image forming apparatus such as the title, name, or identifier of an image forming apparatus, an available printing language, an address of the image forming apparatus and port information by communicating with each connected image forming apparatus. The communication interface unit 120 may inform the user how many image forming apparatuses are connected at one time and how many more connections are available at a given time. According to an exemplary embodiment of the present general inventive concept, the communication interface unit 120 may communicate with a connected image forming apparatus periodically and store information regarding each of the connected plurality of image forming apparatuses in the storage unit 130. The information regarding an image forming apparatus means information necessary for print settings including the type of image forming apparatus, a port, and an available printing language.

The storage unit 130 may store information regarding one or a plurality of image forming apparatuses received from the communication interface unit 120. The storage unit 130 may also temporarily store printing data generated from the universal printer driver unit 140 which will be explained later, and may pre-store a script to store information regarding one or more printing options supported by each model type of image forming apparatus, an available printing language, etc.

The universal printer driver unit 140 may include a plurality of printer drivers corresponding to a plurality of languages, and may perform printing jobs for a plurality of image forming apparatuses operated in different languages. Specifically, if a user wishes to print a document written in an application program, the universal printer driver unit 140 may generate printing data in a language which can be recognized in an image forming apparatus that a user wishes to use to perform the printing job. The universal printer driver 140 may include a search unit 141, a setting unit 142, and a driver unit 143.

The search unit 141 may search for at least one image forming apparatus 200 connectable to the printing control apparatus 100. Specifically, the search unit 141 may search for image forming apparatuses currently connected to the printing control apparatus 100 using the communication interface unit 120, and control the interface unit 110 so that the searched for image forming apparatuses are displayed in a list. In this case, the search unit 141 may control the user interface unit 110 so that the connected image forming apparatuses are arranged and displayed in at least an order of printing history and connection priority. For instance, the search unit 141 may arrange and display the connected image forming apparatuses according to printing history such as printing date, printing time, printing requester, department which requested printing, and printing type and printing priority including color, mono, fax, and printing quality.

The search unit 141 may also arrange and display the connected image forming apparatuses according to connection priority by determining which image forming apparatuses are busy or being queued by other printing control apparatuses to perform higher or lesser priority jobs. If a higher priority job is being queued at one image forming apparatus, then the search unit may search for another available image forming apparatus, or an image forming apparatus assigned a lower priority by the control unit. If no image forming apparatuses are available, the search unit can determine the estimated availability time for the next available image forming apparatus. If a lower priority job is being queued, the search unit may allow the image forming apparatus to pre-empt the lower priority print job, if the lower priority print job has not yet started.

If a user selects an image forming apparatus from among the displayed image forming apparatuses, the search unit 141 may search for information supported by the image forming apparatus regarding the selected image forming apparatus. If the information regarding the image forming apparatus selected by the user is searched for, the search unit 141 may control the user interface unit 110 so that the user may display a printing language supported by the selected image forming apparatus.

Specifically, since an image forming apparatus can support a plurality of printing languages, the search unit 141 may display printing languages supported by the image forming apparatus selected by a user, and one of the printing languages can be selected to print an image. If the image forming apparatus selected by the user supports only one printing language, an operation to display printing languages and select one of them may be omitted. Alternatively, a printing language may be selected automatically according to a predetermined order of setting printing languages. For instance, if a printing language is set to be selected in the order of PS printing language, PCL printing language, and XPS printing language, and the user selects an image forming apparatus which supports PS printing language and PCL printing language, PS printing language may be automatically selected.

The search unit 141 may search for information regarding an image forming apparatus before a user selects an image forming apparatus. For instance, the search unit 141 may search for a connected image forming apparatus via the communication interface unit 120 periodically, and pre-store information regarding a connected image forming apparatuses, including information regarding a printing language supported by each image forming apparatus, in the storage unit 130. Therefore, the search unit 141 may display via the display unit 110 at least one connectable image forming apparatus together with at least one printing language supported by the image forming apparatus, and may control the user interface unit 110 so that image forming apparatuses may be displayed by each printing language supported by each of the image forming apparatuses. Specifically, if information regarding a plurality of connected image forming apparatuses is pre-stored in the storage unit 130, the search unit 141 may display at least one connectable image forming apparatus along with at least one printing language supported by each image forming apparatus, and may control the user interface unit 110 so that image forming apparatuses may be displayed to correspond to the printing language supported by each of the image forming apparatuses. For instance, if an image forming apparatus (A) supports PS printing language and PCL printing language, the search unit 141 may control the user interface unit 110 so that the image forming apparatus (A) can be displayed distinctively, such as ‘PS printing language-image forming apparatus (A)’, and ‘PCL printing language-image forming apparatus (A)’.

The setting unit 142 may set the image forming apparatus selected by a user to be a printable image forming apparatus based on the searched printing language. Specifically, the setting unit 142 may change a driver and a port regarding printing environment information of the printing control apparatus 100 to correspond to the driver of the universal driver unit 140 and port of the image forming apparatus selected by the user based on information regarding a printing language supported by the selected image forming apparatus from among the information searched by the search unit 141.

The setting unit 142 may also set the image forming apparatus selected by the user to be a default image forming apparatus. Specifically, the setting unit 142 may add the image forming apparatus selected by the user to a printer queue, set the added image forming apparatus as a default image forming apparatus, and delete a previous default image forming apparatus from the printer queue. In such a case, the setting unit 142 may determine the title, name or description of the selected image forming apparatus using a pre-defined script for each model, and add the determined title to the printer queue as the title of the selected image forming apparatus. The default image forming apparatus may represent an image forming apparatus to perform a printing job when the user does not select a specific image forming apparatus. The printer queue may represent a group of printers registered in the OS environment of a printing control apparatus. For instance, if a printing control apparatus is operated in Window XP OS environment, the printer queue may be a group of printers present in a “Printer and Fax” selection screen or menu.

The order of operation of adding a selected image forming apparatus to a printer queue and an operation of deleting a previous default image forming apparatus from a printer queue may be changed. In addition, the process of setting the selected image forming apparatus as a default image forming apparatus may be performed automatically. In this case, a picture or a message indicating the change of a default image forming apparatus may be displayed for the user to allow the user to know which image forming apparatuses have been automatically selected to perform a print job.

The driver unit 143 can include a plurality of printer drivers corresponding to a plurality of printing languages. The driver unit 143 may generate printing data using a printer driver corresponding to a selected image forming apparatus. Specifically, the driver unit 143 can include a plurality of printer drivers such as a PS printer driver, a PCL 5 printer driver, PCL 6 printer driver, a SPL printer driver, and a XPS printer driver, and may generate printing data in a form recognizable in an image forming apparatus selected by a user, using a printer driver corresponding to a printer driver setting in a given printing environment. Alternatively, the driver unit 143 may generate printing data using a single driver that supports a plurality of printing languages such as PS, PCL 5, PCL 6, SPS, XPS and others.

Therefore, even if an image forming apparatus recognizing a new printing language is developed, a printer driver corresponding to the new printing language may be added to the driver unit 143, and the printing control apparatus 100 may perform a printing job for the image forming apparatus recognizing a new printing language. Alternatively, a new printing language may be added to the single driver that supports a plurality of printing languages. Accordingly, by adding a new driver or driver program to the universal printer driver 140 it can be easier to implement new development and new models.

The control unit 150 may control the performance of a printing job in a printing language corresponding to a selected image forming apparatus, using a universal printer driver 140. Specifically, if a user's command to perform a printing job is received, the control unit 150 may determine whether the printing job can be performed in the selected image forming apparatus. For example, the control unit 150 may determine whether the selected image forming apparatus supports the printing language generated by the driving unit. If it is determined that the printing job cannot be performed, the control unit 150 controls the search unit 141 to search for an image forming apparatus that supports the selected printing language, which can perform the printing job as described above. If the search unit 141 cannot find an image forming apparatus that uses a printing language supported by the printer driver 140, the control unit may prompt the user to add another driver, or query the user whether the user wants to search the internet for a compatible driver to install.

If it is determined that the selected image forming apparatus can perform the printing job, the control unit 150 may control the driver unit 143 to generate printing data in a printing language supported by the selected image forming apparatus. The control unit 150 may control the communication interface unit 120 so that the generated printing data is transmitted via a port corresponding to the selected image forming apparatus.

If a user's command to change an image forming apparatus is received, and a new image forming apparatus is connected to the printing control apparatus 100, and if a printing job cannot be performed in a previously-set default image forming apparatus, the control unit 150 may perform the following operations.

Specifically, if a user's command to change an image forming apparatus is received, the control unit 150 may receive selection of an image forming apparatus from among the image forming apparatuses connected to the printing control apparatus 100 via the user interface unit 110, and set the selected image forming apparatus to be a printable image forming apparatus.

If a new image forming apparatus is connected, the control unit 150 may display the new image forming apparatus for a user via the user interface unit 110, and set the new image forming apparatus to be a printable image forming apparatus.

If a printing job cannot be performed in a previously-set default image forming apparatus, the control unit 150 may display connectable image forming apparatuses for a user, receive selection of one of them, set the selected image forming apparatus to be a printable image forming apparatus, and perform the above-mentioned process so that the printing job can be executed in the selected image forming apparatus.

In this case, the selected image forming apparatus may become a new default image forming apparatus, and the control unit 150 may control the user interface unit 110 so that information regarding the new default image forming apparatus can be displayed.

Accordingly, the user may perform the printing job using a single universal printing driver without installing a separate driver for each printing language.

In the above exemplary embodiments, the printing control apparatus 100 of the present general inventive concept includes not only a personal computer but also a notebook computer, PDA, PMP, and a cellular phone.

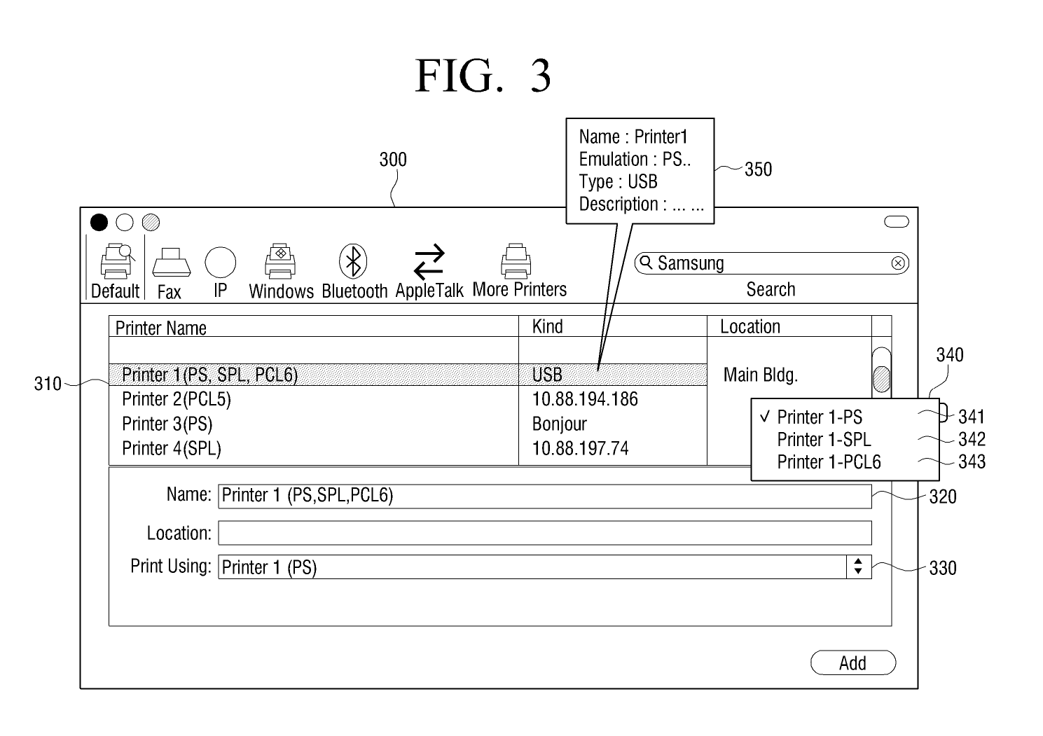

FIG. 3 to FIG. 7 are exemplary views illustrating a user interface window which may be displayed in a printing control apparatus according to an exemplary embodiment of the present general inventive concept.

Referring to FIG. 3, the UI window 300 includes an available printer display area 310 to display descriptions of a selected plurality of image forming apparatuses connected to a printing control apparatus 100. The window 300 also may include selected printer identification areas 320 and a printing language display area 330 to display the name of an image forming apparatus and printing language selected by a user from among the displayed image forming apparatuses and printing languages.

The available printer display area 310 can display a plurality of image forming apparatuses connected to a printing control apparatus 100 and display an image forming apparatus which is currently connected to the printing control apparatus 100. In the exemplary embodiment, ‘Printer 1’ supporting PS, SPL, and PCL 6 printing languages, ‘Printer 2’ supporting PCL 5 printing language, ‘Printer 3’ supporting PS printing language, and ‘Printer 4’ supporting SPL printing language are illustrated. The title of image forming apparatuses may be displayed according to the printing language that each of the image forming apparatuses support. For instance, ‘Printer 1’ which supports PS, SPL, and PCL 6 printing languages may be distinctively displayed such as ‘Printer 1(PS)’, ‘Printer 1(SPL)’, and ‘Printer 1(PCL 6).’

The selected printer identification area 320 and printing language display area 330 that display the image forming apparatus selected by a user may display the image forming apparatus selected by the user and the printing language supported by the selected image forming apparatus. Specifically, if the user selects ‘Printer 1’ from the available printer display area 310 to display a plurality of image forming apparatuses, a printer description area 350 that displays information regarding the selected image forming apparatus is displayed, and if the selected image forming apparatus supports a plurality of printing languages, a printing language receiving area 340 to receive selection of a printing language may be displayed. Accordingly, a user may easily check information regarding the selected image forming apparatus and select an image forming apparatus and a printing language for the image forming apparatus. In an embodiment of the present general inventive concept, the printing language receiving area 340 to receive selection of a printing language may or may not be displayed. Specifically, if there is a predetermined priority regarding a plurality of printing languages, a printing language may be selected automatically according to the priority.

In this way, a user may check the availability of a printable image forming apparatus and select an image forming apparatus from among the displayed image forming apparatuses.

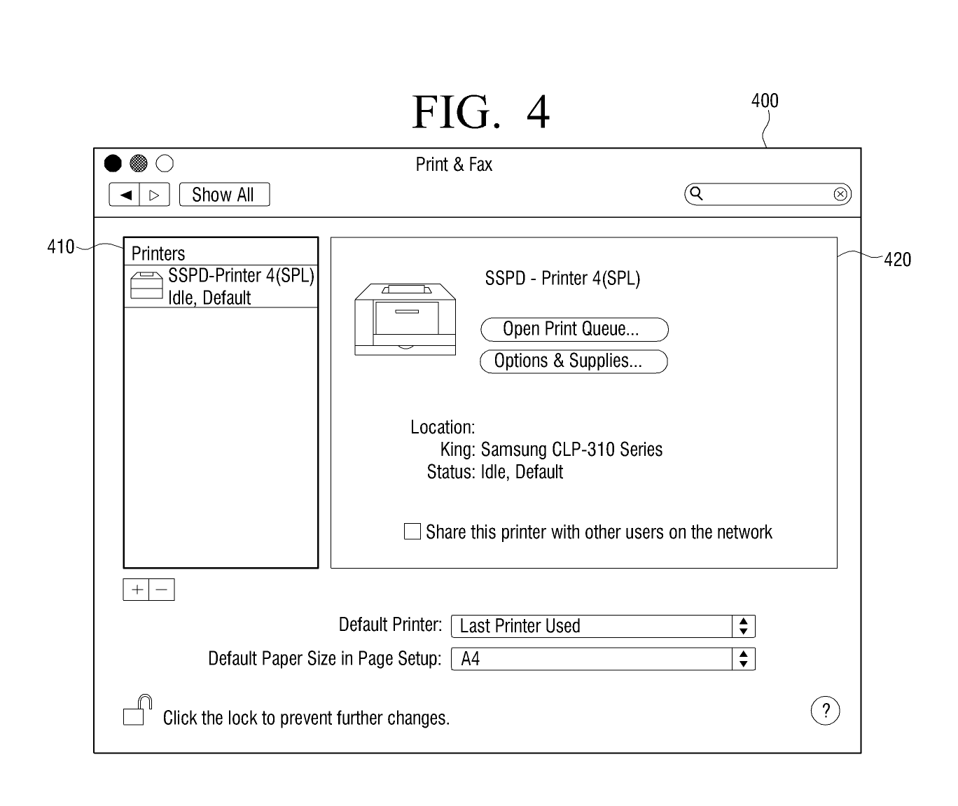

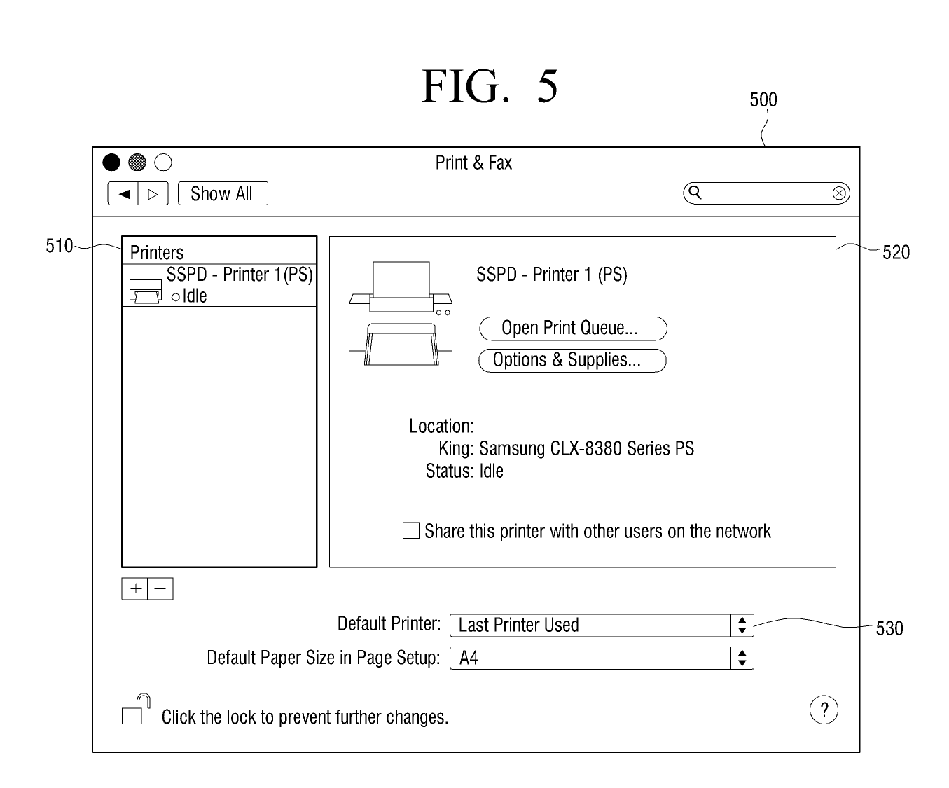

FIG. 4 is illustrates a UI window 400 displaying a printer queue before a user selects the image forming apparatus ‘Printer 1 (PS)’ displayed in FIG. 3, and FIG. 5 illustrates a UI window 500 displaying a printer queue after the user selects an image forming apparatus from among the image forming apparatuses displayed in FIG. 3. Comparing printer display area 410 in FIG. 4 with printer display area 510 in FIG. 5, it can be seen that the previously selected SPL printer driver of ‘Printer 4 (SPL)’ may be changed to the PS printer driver of ‘Printer 1 (PS)’ as selected in FIG. 3. In addition, ‘Last Printer Used’ may be set as a default image forming apparatus in a default printer display area 530 illustrated in FIG. 5, which means that the most recently used image forming apparatus is set as a default image forming apparatus. A user may change the tab to set the current image forming apparatus to be continuously operated as a default image forming apparatus.

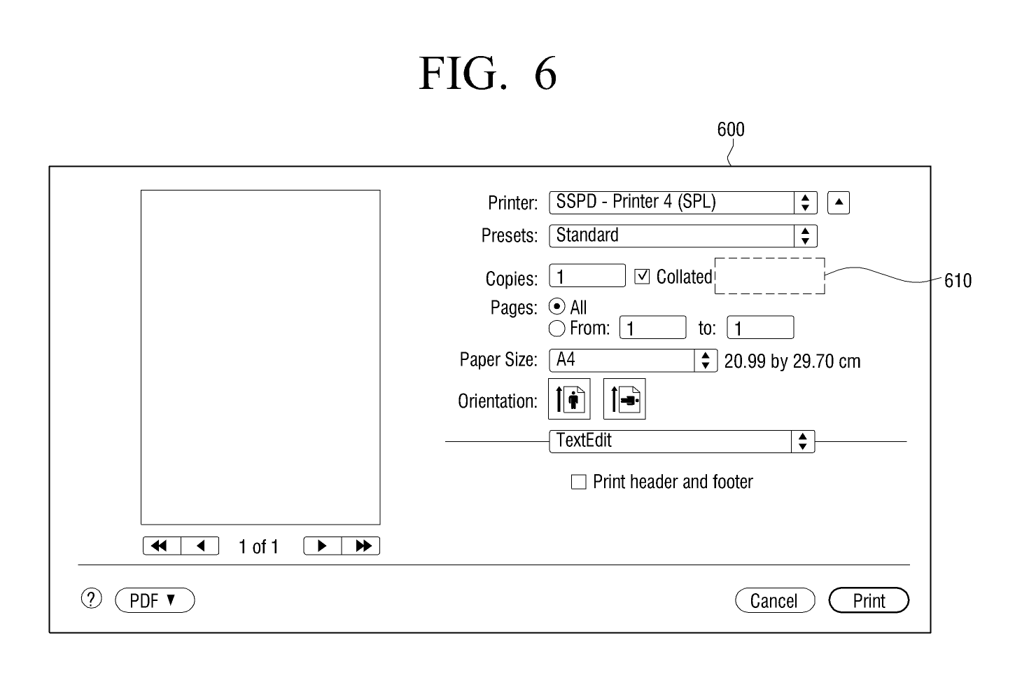

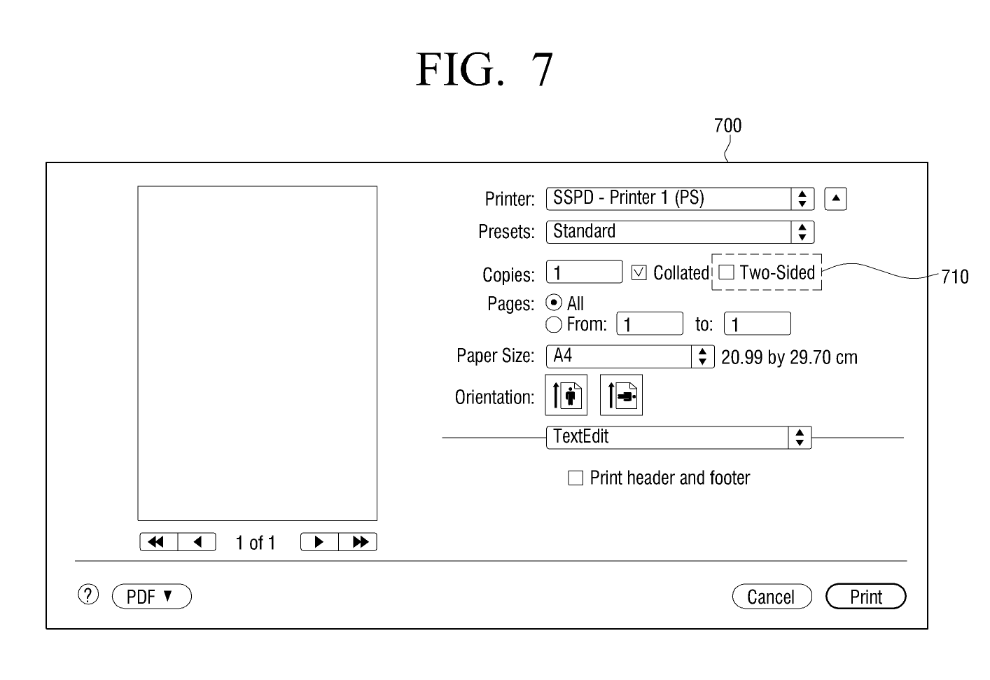

FIG. 6 illustrates a UI window 600 to receive printing options of one of a plurality of image forming apparatuses before a user selects an image forming apparatus from among the image forming apparatuses displayed in FIG. 3, and FIG. 7 illustrates a UI window 700 to receive one or more printing options of the image forming apparatus after the user has selected the image forming apparatus from among the image forming apparatuses displayed in FIG. 3. The plurality of image forming apparatuses may include a number of different printing options such as one-sided or two-sided printing, available paper size, available paper orientation, finishing options, and others. Comparing the collated box area 610 in FIG. 6 with the collated box area 710 in FIG. 7, it can be seen that Two-Sided' printing option is not displayed in the collated box are 610 which may indicate that the Two-Sided' printing option is not supported in the previous image forming apparatus, ‘Printer 4 (SPL)’ illustrated in FIG. 4. On the contrary, the Two-Sided' printing option displayed in the collated box 710 can be supported in the newly selected image forming apparatus, ‘Printer 1 (PS)’ illustrated in FIG. 5. Thus, a user is able to scroll through a list of image forming apparatuses to determine desirable print options that may be supported by different printing languages.

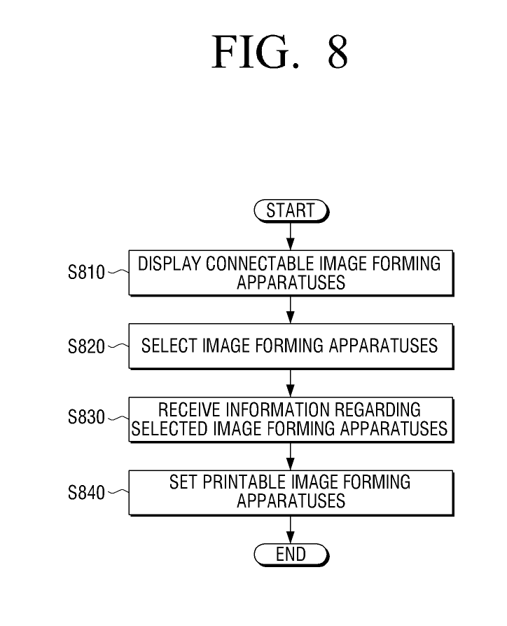

FIG. 8 is a flow chart illustrating a printing control method according to an exemplary embodiment of the present general inventive concept.

Referring to FIG. 8, at least one image forming apparatus connectable to a printing control apparatus may be displayed (operation S810) within the user interface unit 110 (illustrated in FIG. 4), and at least one connectable image forming apparatus from among displayed image forming apparatuses may be received (operation S820). Specifically, the at least one image forming apparatus currently connected to the printing control apparatus 100 may be searched for, and the connected image forming apparatuses may be displayed in a list. In this case, the connected image forming apparatuses may be arranged and displayed according to at least one of printing history of the connected image forming apparatus and connection priority. The printing languages supported by the connected image forming apparatuses may also be displayed, and a user may select a desired image forming apparatus and a printing language for the image forming apparatus to perform printing. In this case, image forming apparatuses may be displayed according to the printing language supported by each of the connected image forming apparatuses.

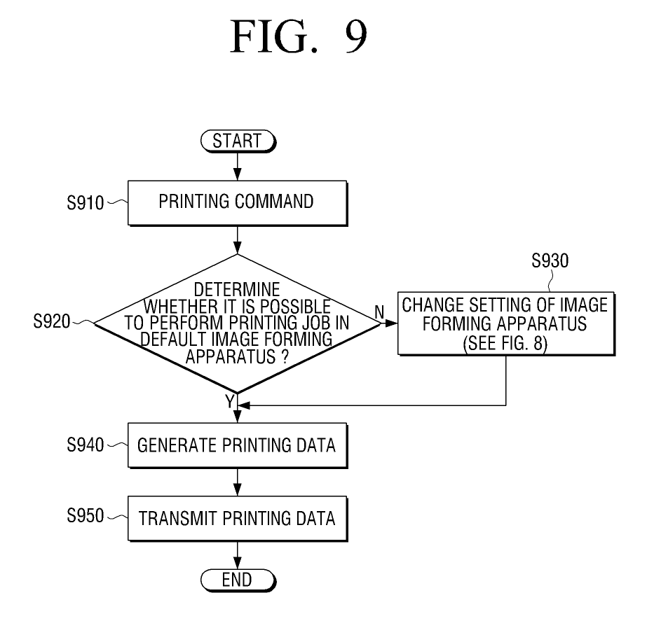

If one image forming apparatuses from among the displayed image forming apparatuses is selected, the selected image forming apparatus may be set as a printable image forming apparatus. Specifically, at least one printing language supported by the selected image forming apparatus may be searched (operation S830) to see if the driver 400 supports the printing language. One printing language from among the searched languages is set as a printing language, and the selected image forming apparatus may be registered as a printable image forming apparatus (operation S840). After operation 840, the selected image forming apparatus may be ready to generate printing data and transmit printing data, as further illustrated in FIG. 9. Information regarding the image forming apparatus may be information necessary to set a printing environment and can include the type and port of an image forming apparatus and a printing language supported by the image forming apparatus. Information searching may be performed after a user's selection of an image forming apparatus, or may be performed before a connectable image forming apparatus is displayed.

Information which has been searched regarding the image forming apparatus selected by a user may be displayed for the user. Specifically, information regarding at least one printing language supported by the image forming apparatus from among information searched regarding the image forming apparatus may be displayed for a user. At least one printing language from among the displayed printing languages is selected by the user, and a printer driver within the driver unit or the universal printer driver may be selected based on this information. In addition, the selected image forming apparatus may be set as a default image forming apparatus. Specifically, the image forming apparatus selected by the user may be added to a printer queue, the image forming apparatus added to the printer queue may be set as a default image forming apparatus, and the previous default image forming apparatus may be deleted from the printer queue, so that the image forming apparatus selected by the user can be set as a default image forming apparatus. In this case, the title, name, or description of the image forming apparatus added to the printer queue may be determined using a pre-defined script for each mode. After the default image forming apparatus is changed, a picture or a message informing the change of the default image forming apparatus may be displayed for the user.

FIG. 9 is a flow chart illustrating a printing control method according to an exemplary embodiment of the present general inventive concept.

Referring to FIG. 9, if a command to perform a printing job is received (operation 910), a determination is made whether the printing job can be performed in a default (standard) image forming apparatus. Specifically, it may be determined whether the printing job can be performed in the image forming apparatus set as a default image forming apparatus (operation 920). If it is determined that the printing job cannot be performed using the default image forming apparatus, the process (operation 930) illustrated in FIG. 8 may be performed.

On the other hand, if a determination is made that the printing job can be performed in the image forming apparatus set as the default image forming apparatus, printing data may be generated using a printing language corresponding to the image forming apparatus selected by the user (operation S940). Specifically, printing data may be generated using a printer driver corresponding to a printing language of the selected image forming apparatus in the universal printer driver.

The generated printing data may be transmitted using a port corresponding to the selected image forming apparatus (operation S950). Specifically, the printing data which has been converted into a printing language corresponding to the selected image forming apparatus may be transmitted to the port corresponding to the selected image forming apparatus.

Accordingly, a user may perform a printing job using a universal printer driver without installing a separate driver for a plurality of image forming apparatuses operated in different languages, and thus user convenience is enhanced.

The printing control methods illustrated in FIG. 8 and FIG. 9, and discussed herein, may be employed not only in a printing control apparatus having the structure illustrated in FIG. 2 but also in a printing control apparatus having other structures.

The foregoing exemplary embodiments and advantages are merely exemplary and are not to be construed as limiting the present general inventive concept. The present teaching can be readily applied to other types of apparatuses. Also, the description of the exemplary embodiments of the present general inventive concept is intended to be illustrative, and not to limit the scope of the claims, and many alternatives, modifications, and variations will be apparent to those skilled in the art.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A printing control method of a printing control apparatus, using a universal printer driver corresponding to a plurality of printing languages, comprising:
displaying at least one image forming apparatus connectable to the printing control apparatus;
receiving selection of at least one image forming apparatus from among the displayed image forming apparatuses;
setting at least one image forming apparatus from among the selected image forming apparatuses as a printable image forming apparatus;
generating printing data using a printing language corresponding to the set image forming apparatus; and
transmitting the generated printing data to the at least one selected image forming apparatus.

2. The printing control method as claimed in claim 1, wherein the generating printing data generates printing data using a printer driver corresponding to a printing language of the selected image forming apparatus in the universal printer driver.

3. The printing control method as claimed in claim 1, wherein the setting at least one image forming apparatus as a printable image forming apparatus, comprising:
searching for at least one printing language supported by the selected image forming apparatus; and
setting a printing language from among the searched for printing languages as a printing language and registering the selected image forming apparatus as a printable image forming apparatus.

4. The printing control method as claimed in claim 3, further comprising:
displaying at least one printing language supported by the selected image forming apparatus.

5. The printing control method as claimed in claim 3, wherein the registering a printable image forming apparatus sets the selected image forming apparatus as a default image forming apparatus.

6. The printing control method as claimed in claim 5, further comprising:
displaying change of a default image forming apparatus.

7. The printing control method as claimed in claim 1, wherein the displaying displays the connected image forming apparatus distinctively according to a printing language supported by the image forming apparatus, or displays a printing language supported by the image forming apparatus together with the image forming apparatus.

8. The printing control method as claimed in claim 1, wherein the displaying arranges and displays the connected image forming apparatus according to at least one of printing history and connection priority of the connected image forming apparatus.

9. The printing control method as claimed in claim 1, wherein the displaying is performed when a user's command to change an image forming apparatus is received, when a new image forming apparatus is connected to the printing control apparatus, or when a printing job cannot be performed in a predetermined default image forming apparatus.

10. A printing control method of a printing control apparatus, using a universal printer driver corresponding to a plurality of printing languages, comprising:
displaying at least one image forming apparatus connectable to the printing control apparatus and a printing language supported by the image forming apparatus;
receiving selection of one of the displayed image forming apparatus and the printing language;
generating printing data using the selected printing language; and
transmitting the generated printing data to the image forming apparatus.

11. A printing control apparatus, comprising:
a universal printer driver capable of performing a printing job for a plurality of image forming apparatuses and supporting a plurality of printing languages;
a user interface unit to display at least one image forming apparatus connectable to the printing control apparatus and receive selection an image forming apparatus from among the displayed image forming apparatuses; and
a control unit to generate printing data in a printing language corresponding to the at least one selected image forming apparatus using the universal printer driver and transmit the generated printing data to the at least one selected image forming apparatus.

12. The printing control apparatus as claimed in claim 11, wherein the universal printer driver, comprising:
a search unit to search for at least one image forming apparatus connectable to the printing control apparatus and search for a printing language supported by the at least one image forming apparatus;
a setting unit to set the at least one image forming apparatus as a printable image forming apparatus based on the searched printing language; and
a driver unit to include a plurality of printer drivers corresponding to a plurality of printing languages and generate printing data using a printer driver corresponding to the selected image forming apparatus.

13. The printing control apparatus as claimed in claim 12, wherein the control unit transmits the generated printing data via a port corresponding to the at least one selected image forming apparatus.

14. The printing control apparatus as claimed in claim 12, wherein the setting unit sets the searched for image forming apparatus as a default image forming apparatus.

15. The printing control apparatus as claimed in claim 14, wherein the user interface unit informs that a default image forming apparatus is changed.

16. The printing control apparatus as claimed in claim 11, wherein the user interface unit displays the connected image forming apparatuses distinctively according to a printing language supported by the image forming apparatus or displays a printing language supported by the image forming apparatus together with the image forming apparatus.

17. The printing control apparatus as claimed in claim 11, wherein the user interface unit displays at least one image forming apparatus connectable to the printing control apparatus and printing languages supported by the connectable image forming apparatus, and receives section of a printing language from among the displayed languages, and
wherein the control unit generates printing data in the selected printing language using the universal printer driver and transmits the generated printing data to the at least one selected image forming apparatus.

18. The printing control apparatus as claimed in claim 11, wherein the user interface unit arranges and displays the connected image forming apparatuses according to at least one of printing history or connection priority of the connected image forming apparatus.

19. The printing control apparatus as claimed in claim 11, wherein the user interface unit is operated when a user's command to change an image forming apparatus is received, when a new image forming apparatus is connected to the printing control apparatus, or when a printing job cannot be performed in a predetermined default image forming apparatus.

20. A method of printing using a printing control apparatus, the method comprising:
determining desired printing options to correspond to an image forming apparatus;
displaying a plurality of image forming apparatuses with different printing options and printing languages supported by the image forming apparatuses;
selecting an image forming apparatus to correspond to the desired printing options; and
generating printing data in a printing language to correspond to the selected image forming apparatus with the selected printing options.

21. The method of claim 20, further comprising:
determining whether a displayed image forming apparatus is able to print the desired printing options.

22. A printing control apparatus, comprising:
a control unit to determine at least one printing option of an image forming apparatus;
a user interface unit to display a plurality of image forming apparatuses with different sets of printing options and printing languages supported by the image forming apparatuses; and
a universal driver unit to search available image forming apparatuses, set an image forming apparatus as a printable image forming apparatus, and generate printing data in a printing language to correspond to the printing options of the selected image forming apparatus.

23. The printing control apparatus of claim 22, wherein the control unit determines whether a displayed image forming apparatus is able to print the at least one printing option.
